(19) United States
(12) Patent Application Publication
(10) Pub. No.: US 2013/0009916 A1
(43) Pub. Date: Jan. 10, 2013

(54) 3D LIQUID CRYSTAL SHUTTER GLASSES

(75) Inventor: WEN-WEI TSENG, Guangdong (CN)

(73) Assignee: LI-TEK CORPORATION CO., LTD., Guangdong (CN)

(21) Appl. No.: 13/178,526

(22) Filed: Jul. 8, 2011

(51) Int. Cl. G09G 3/36; G09G 5/00

(52) U.S. Cl. 345/204; 345/87

(57) ABSTRACT

3D liquid crystal shutter glasses in the present invention include LCD lenses (1) and a control circuit (20, 30) which is operable to receive sync RF signal and drive the LCD lenses operation. The control circuit includes: an RF receiver for receiving sync signal (2); an LCD driver (3) for driving the LCD lenses operation; a boost circuitry (4) for supplying an operating voltage to the LCD driver; a CPU (5) for controlling the RF receiver, LCD driver and boost circuitry; a power control module (7); and a battery (6) for powering the control circuit via the power control module. The glasses can eliminate the impact from light in environment and the orientation limited, and improve the viewing effect and quality of 3D image or video. Therefore, it is more practical.

### BACKGROUND OF THE INVENTION

The present invention relates to an image or video viewing systems and apparatuses, and especially to 3D liquid crystal shutter glasses.

In nowadays, three dimensional (3D) image display technology is applied in a wide variety of fields, including stereoscopic movie, amusement park, liquid crystal television (LCTV), and the like. The user needs to wear 3D glasses for viewing displayed 3D image or video. The traditional 3D glasses receive signal via infrared receiver. However, the infrared signal tends to be affected by the light in the environment, such as fluorescent lamp or any other light, which will impact the 3D glasses flashing or glaring thereon, and accordingly the image perceived by the user is very poor in quality. So, if the user views the displayed 3D image via the 3D glasses for a relative long time, he will feel very tired, and his eyesight will be hurt. Furthermore, the infrared signal can be transmitted in a definite angle range or orientation. Out of the angle range, or meeting an obstacle, the infrared signal cannot be transmitted to the 3D glasses, thus the user cannot appreciate the displayed image. In fact, the 3D glasses are not well practicable.

Therefore, improved 3D liquid crystal shutter glasses are desired which overcomes the disadvantages of the prior art.

### BRIEF SUMMARY OF THE INVENTION

A main object of the present invention is to provide a practicable 3D liquid crystal shutter glasses, which can eliminate the impact from light in environment and the orientation, and improve the viewing effect and quality of 3D image or video.

To obtain the above object, a pair of 3D liquid crystal shutter glasses in the present invention comprise left and right LCD lenses and a control circuit associated with the LCD lenses. The control circuit is operable to receive sync RF signal and drive the LCD lenses operation. The control circuit comprises: an RF receiver for receiving sync signal; an LCD driver for driving the LCD lenses operation; a boost circuitry for supplying an operating voltage to the LCD driver; a CPU for controlling the RF receiver, LCD driver and boost circuitry; a power control module; and a battery for powering the control circuit via the power control module.

The power control module is associated with the battery for controlling battery recharging.

In an embodiment, the LCD driver is associated with LCD lenses; the boost circuitry is associated with the LCD driver; and the CPU is respectively associated with the RF receiver, LCD driver and boost circuitry. In operation, the CPU controls the RF receiver to receive proper signals from a sync transmitter in an external source; according to the sync signal, the CPU outputs a command to the LCD driver for driving the LCD lens operation, and a command to the boost circuitry to power the LCD driver; according to the commands from the CPU, the boost circuitry outputs a drive voltage to the LCD driver, thereby the LCD driver starts to control the LCD lenses to turn on and off.

Preferably, the battery is a lithium battery, and the power control module employs a regular voltage regulator for voltage-stabilizing. The RF receiver is selective from a chip of CC2500 or A7105. The LCD driver is selective from a chip of CD4053. The CPU is selective from a chip of MSP430F2121 or MSP430F2132.

In another embodiment, the LCD driver, boost circuitry and power control module are integrated in an MPU. Thereby, the CPU is respectively associated with the RF receiver and MPU; the RF receiver and the battery are respectively associated with MPU; and the MPU is associated with LCD lenses. In operation, the CPU controls the RF receiver receiving proper signals from a sync transmitter in an external source, then the CPU outputs a command according to the sync signal to the MPU. Thereby the MPU drives the LCD lenses to turn on and off.

Preferably, the MPU is selective from a chip of TPS65735.

The 3D liquid crystal shutter glasses of the present invention have an RF receiver, and the control circuit to control the LCD lenses turning on and off, which can eliminate the impact from light in environment and the orientation limited, and improve the viewing effect and quality of 3D image or video. Therefore, it is more practical.

Other objects, advantages and novel features of the invention will become more apparent from the following detailed description of a preferred embodiment thereof when taken in conjunction with the accompanying drawings, wherein:

### BRIEF DESCRIPTION OF THE DRAWINGS

FIG. 1 is a diagrammatic view of 3D liquid crystal shutter glasses in accordance with a first embodiment of the present invention;

FIG. 2 is a diagrammatic view of 3D liquid crystal shutter glasses in accordance with a second embodiment of the present invention;

FIG. 3 illustrates a schematic diagram of the 3D liquid crystal shutter glasses of FIG. 1;

FIG. 4 illustrates another schematic diagram of the 3D liquid crystal shutter glasses of FIG. 1;

FIG. 5 illustrates a schematic diagram of the 3D liquid crystal shutter glasses of FIG. 2; and

FIG. 6 illustrates another schematic diagram of the 3D liquid crystal shutter glasses of FIG. 2.

### DETAILED DESCRIPTION OF THE INVENTION

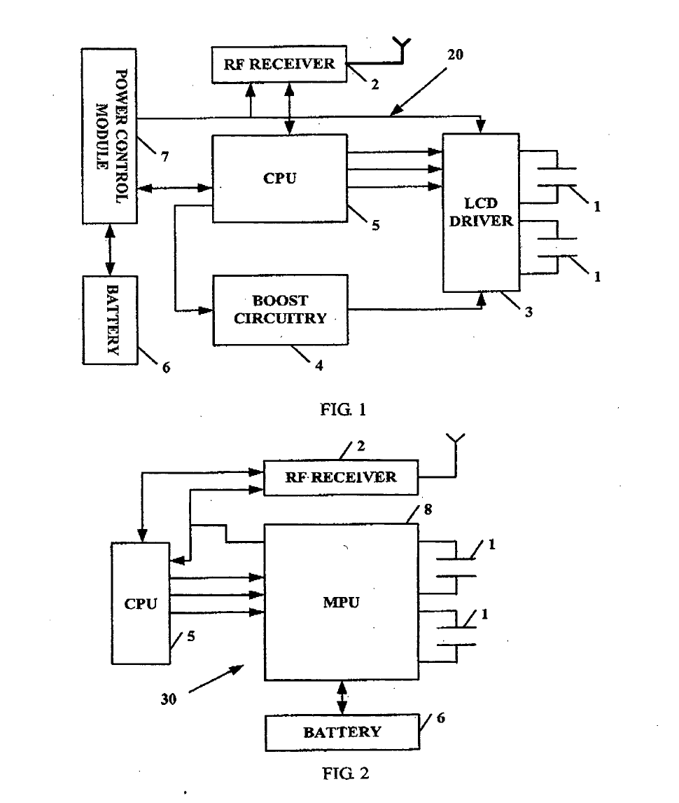

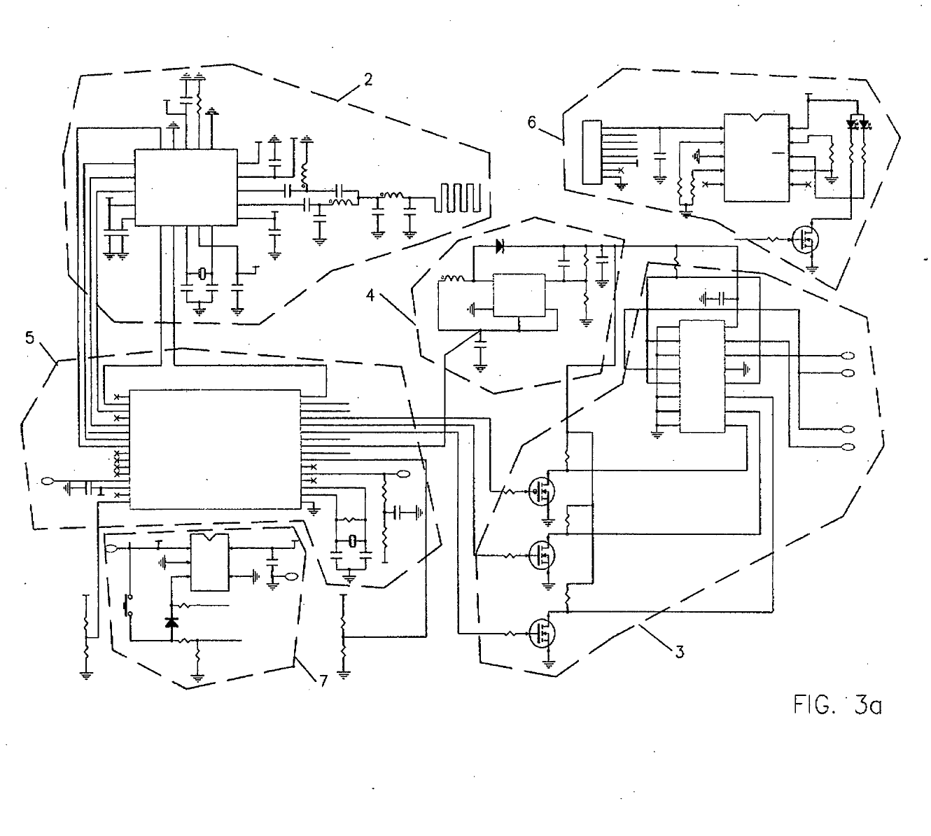

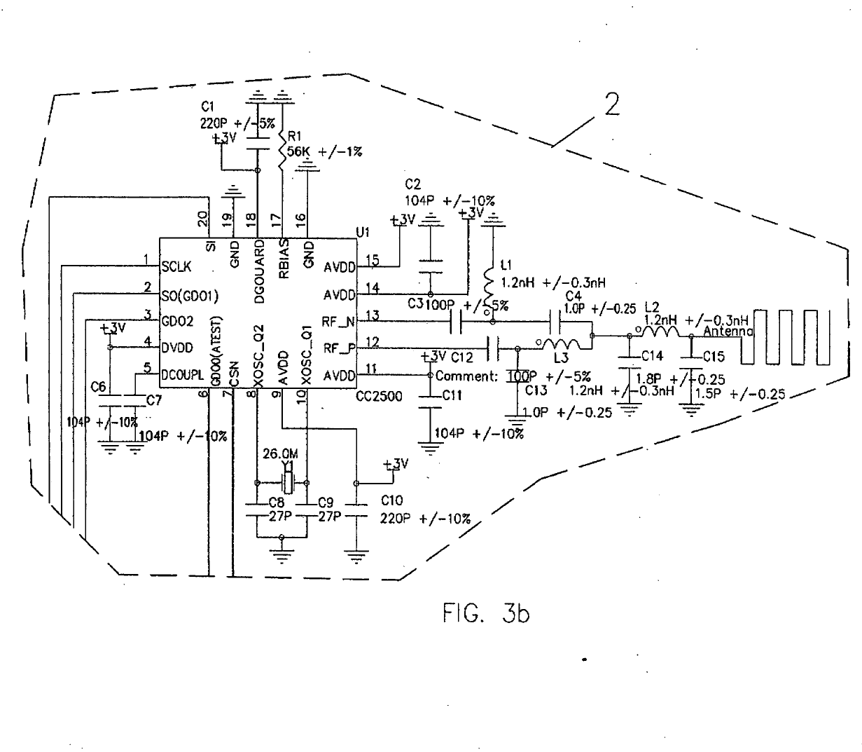

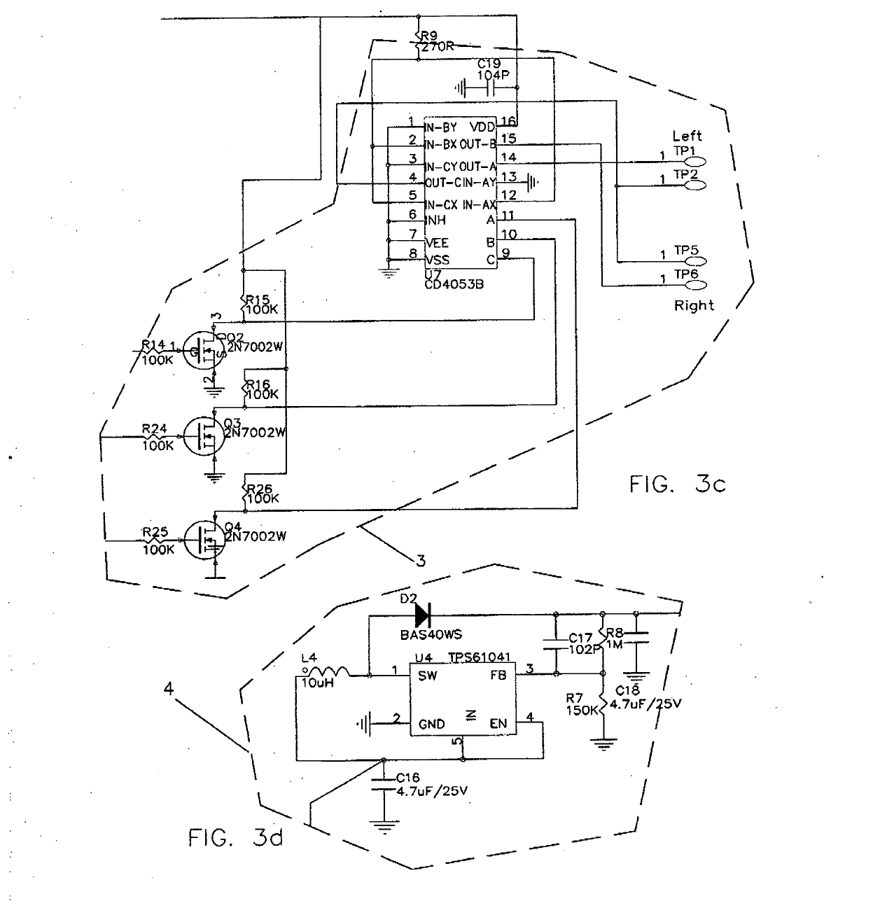

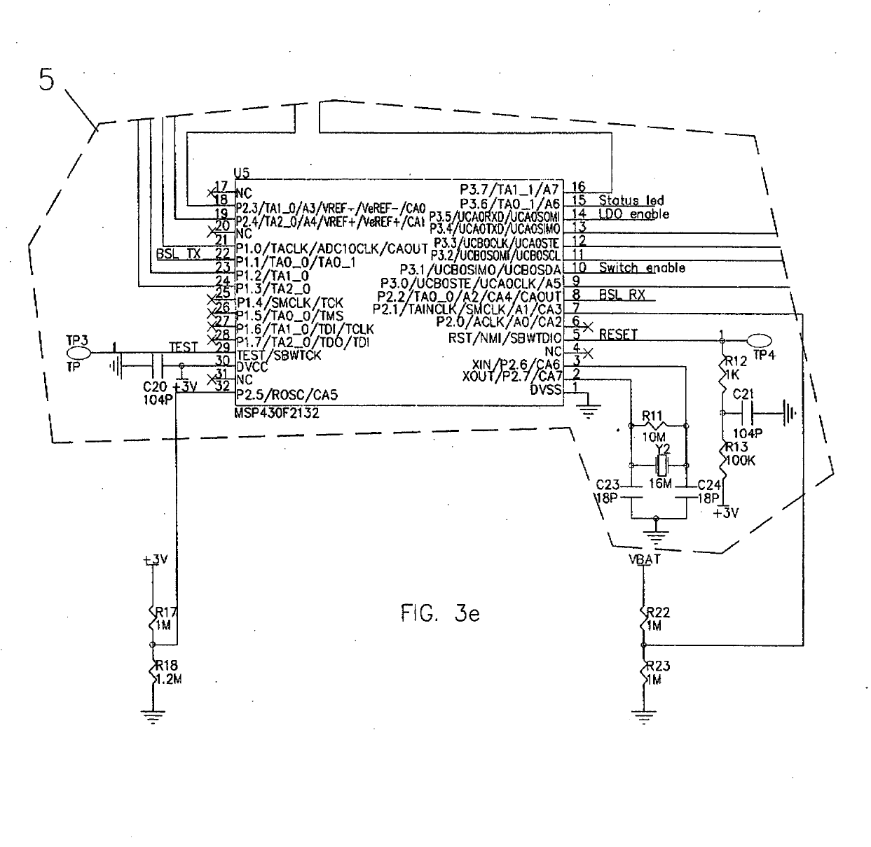

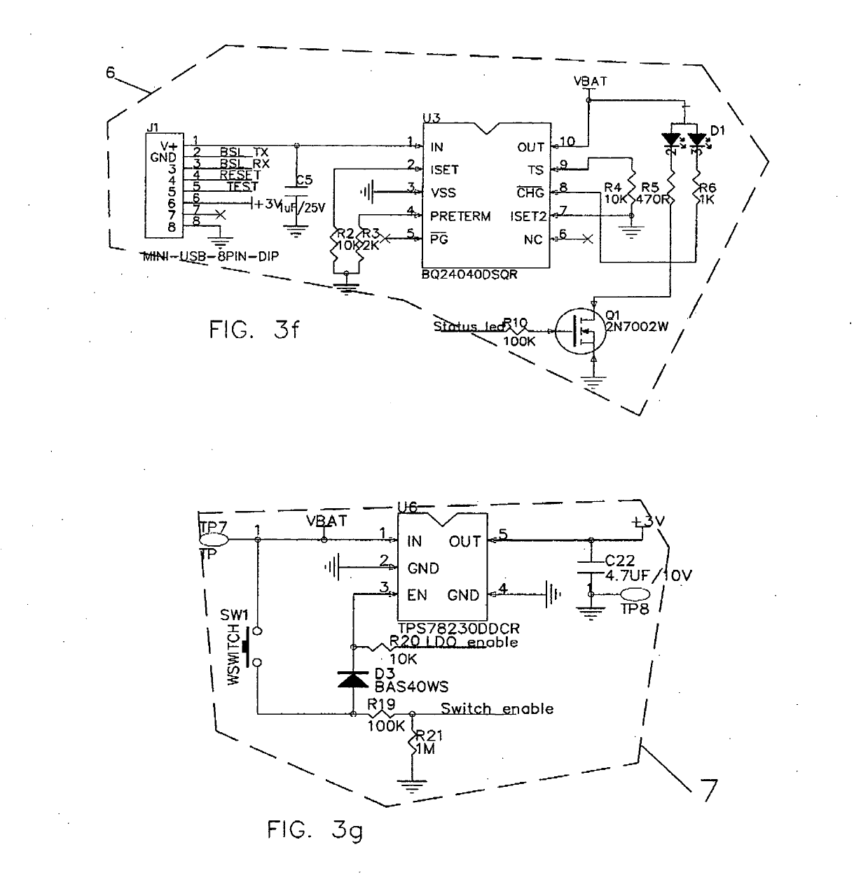

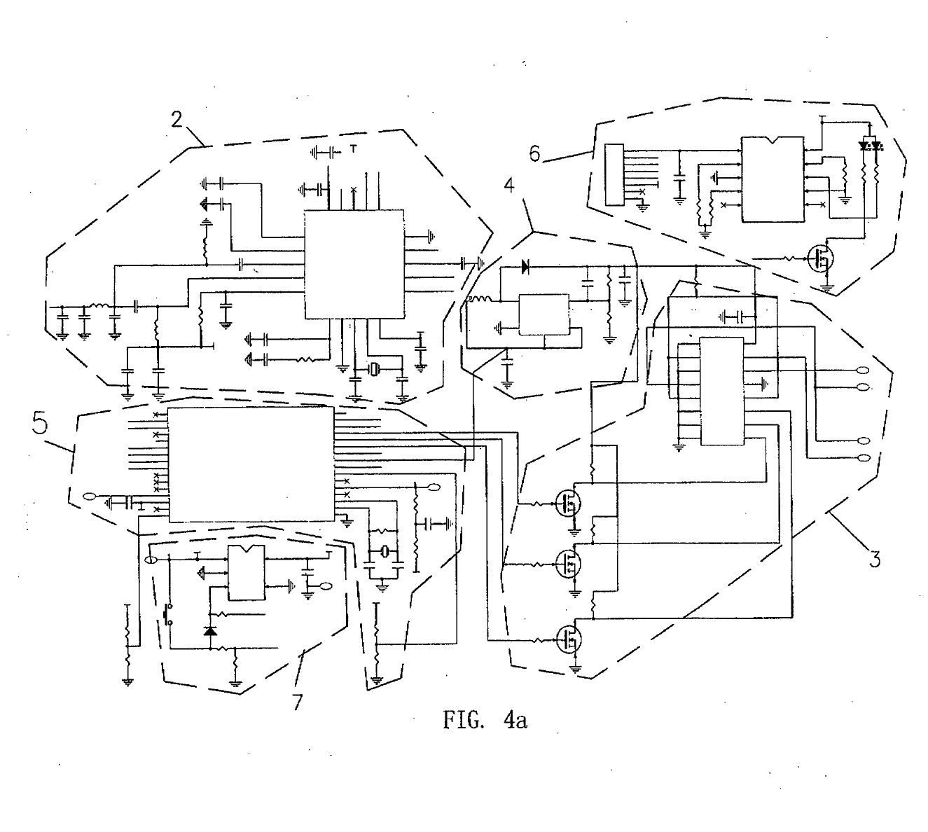

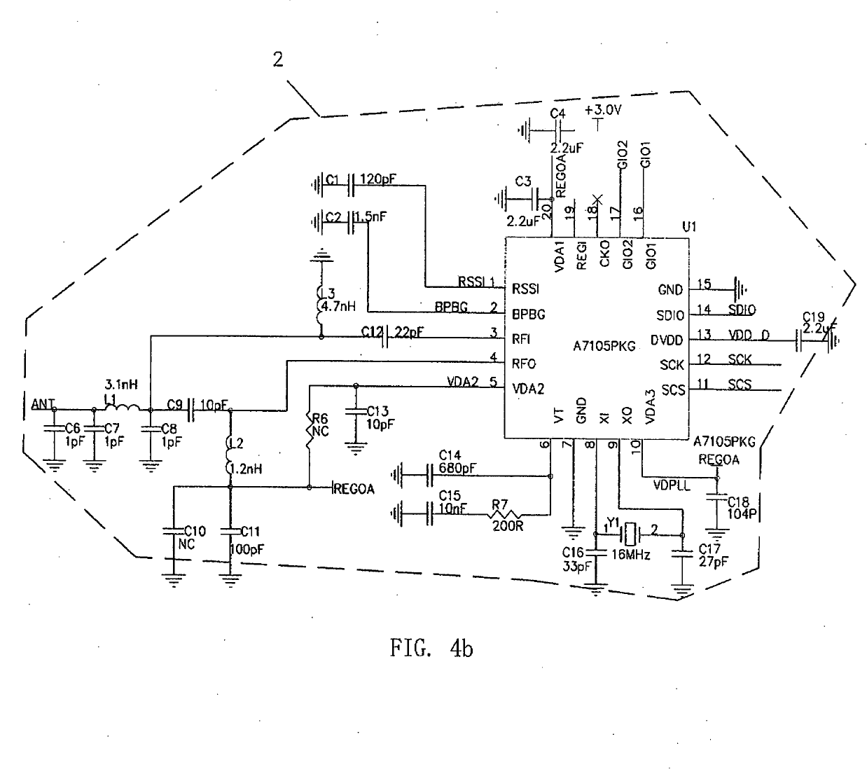

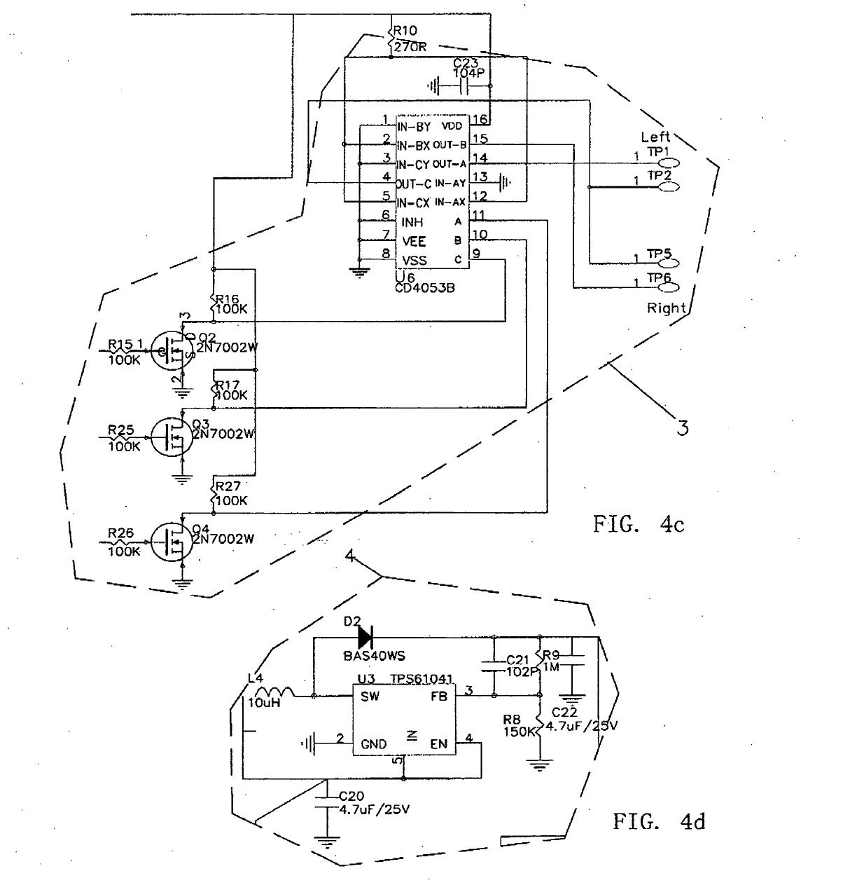

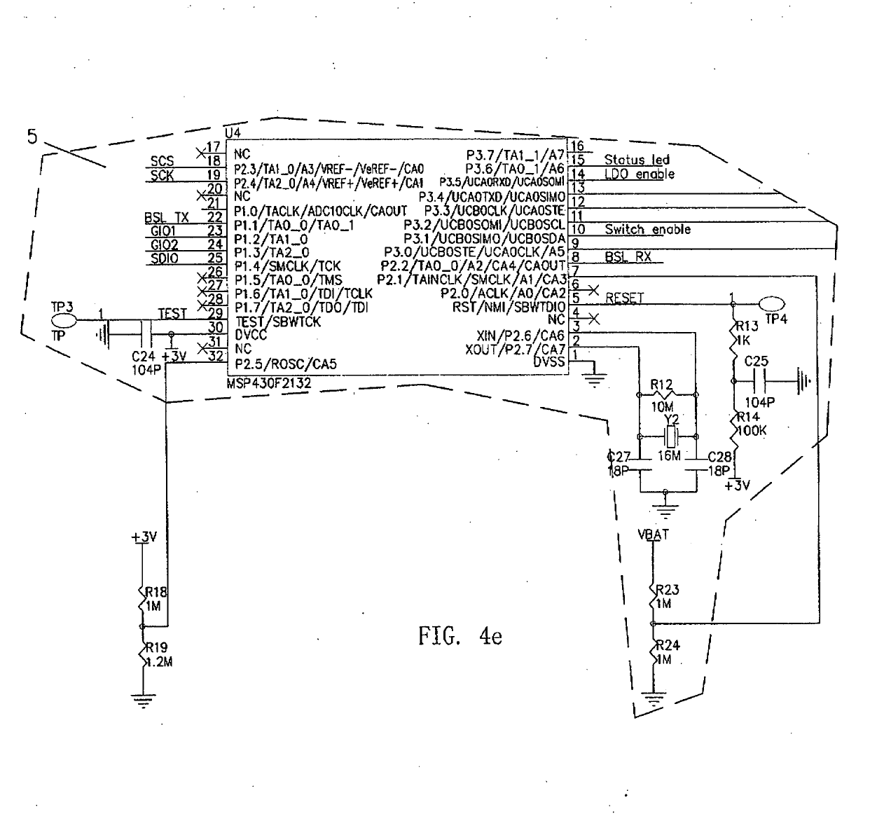

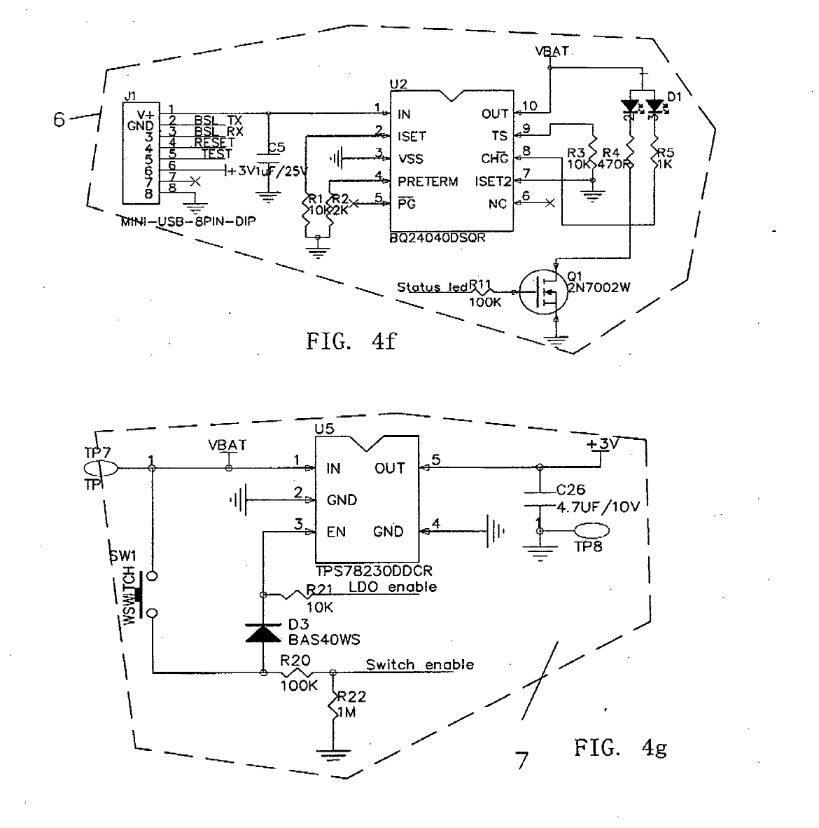

Referring to FIG. 1, 3D liquid crystal shutter glasses according to the first embodiment of the present invention include left and right LCD lenses 1 and control circuit 20 associated with LCD lenses 1. Referring to FIGS. 3-4 together, the control circuit 20 associated with LCD lenses 1 comprises RF receiver 2, LCD driver 3, boost circuitry 4, central processing unit (CPU) 5, and power supply which includes battery module 6 and power control module 7, electronically associated in the way as shown in FIG. 1. FIGS. 3 and 4 respectively illustrate two specific electronic circuit diagrams of the control circuit 20, which are also protected in the scope of this invention.

The RF receiver 2 be selected from (but not limited to) a chip of CC2500 or A7105, for receiving synchronization signal may.

The LCD driver 3 is operable to control LCD lenses 2 operation, and it may be selected from (but not limited to) a chip of CD4053.

The boost circuitry 4 is associated with the LCD driver 3 and output a drive voltage to the LCD driver 3.

The CPU 5 is respectively associated with the RF receiver 2, LCD driver 3 and boost circuitry 4 so as to control them working. The CPU 5 may be selected as but not limited to the type of MSP430F2121 or MSP430F2132.

The power supply operates as a power source for the control circuit 20. The power control module 7 thereof is associated with battery module 6. The power control module 7 is operable to power the RF receiver 2, LCD driver 3, boost circuitry 4, and the CPU 5, and control recharging the battery module 6. The battery module 6 preferably is lithium battery, and is operable to supply power to the control circuit 20 via the power control module 7.

When the 3D glasses in operation in accordance with the first embodiment as shown in FIGS. 1, 3-4, the RF receiver 2 is provided to receive a synchronization signal from an external source which comes from a sync signal transmitter linked to a liquid crystal TV, digital projector, computers or any other three-dimensional or stereoscopic devices. The CPU 5 operates to control the RF receiver 2 receiving proper signals, and then outputs commands respectively to the LCD driver 3 and the boost circuitry 4. According to the commands from the CPU 5, the LCD driver 3 and the boost circuitry 4 start to work, and the boost circuitry 4 outputs a drive voltage to the LCD driver 3. More specifically, when the RF receiver 2 receives a sync signal, the CPU 5 will output a command according to the sync signal to the LCD driver 3, and at the same time initiate the boost circuitry 4 to power the LCD driver 3, finally, the left and right LCD lenses 1 are prompted by the driver 3 to turn on and off accordingly.

The boost circuitry 4 is controlled by the CPU 5 to power the LCD driver 3. When the boost circuitry 4 is input a starting signal (command) from the CPU 5, it will output a power signal (namely, power voltage or driving voltage) to LCD driver 3 so that the driver 3 is energized to control the LCD lens to turn on/off according to the command from CPU 5.

The LCD driver 3 is controlled by the CPU 5, and is operable to drive the LCD lenses 1. When the driver 3 is input a control signal (command) from the CPU 5 and a driving voltage from the boost circuitry 4, it will operate according to the command from CPU 5 to control the left lens 1 or the right lens 1 to turn on or off.

The power control module 7 is operable to control the battery 6 recharging, and employs a regular voltage regulator such as a low dropout regulator (LDO) for voltage-stabilizing. Furthermore, the power control module 7 is operable to supply operating voltage to the RF receiver 2, the LCD driver 3, boost circuitry 4, and CPU 5.

The lithium battery 6 as a power source is operable to power the whole control circuit 20.

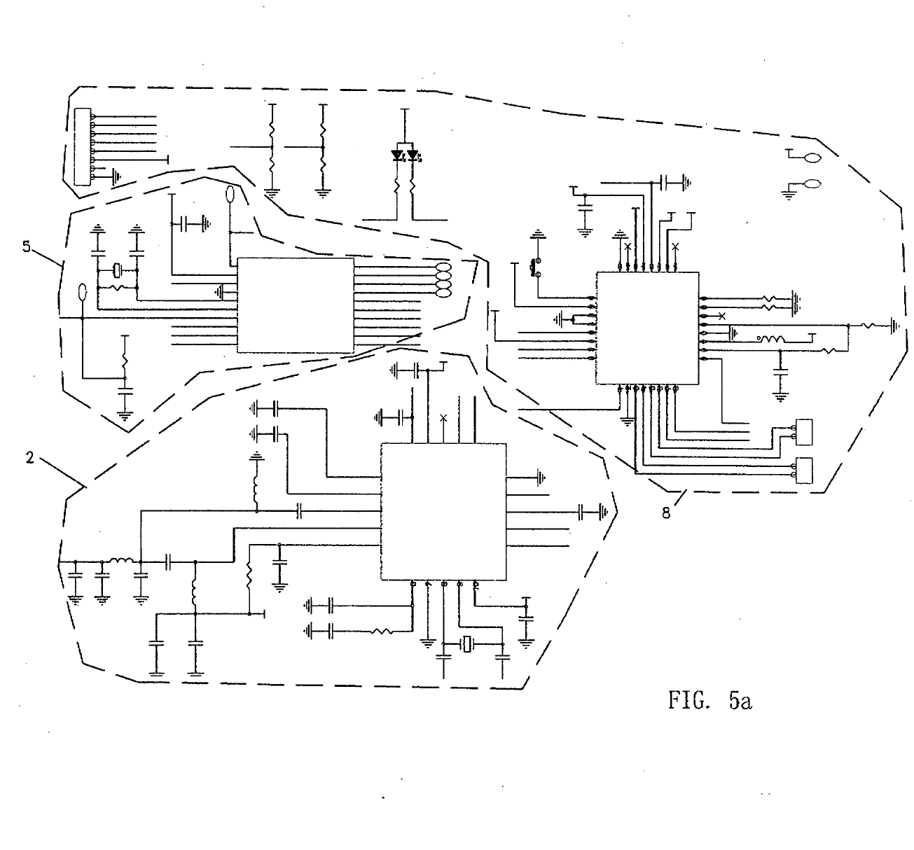

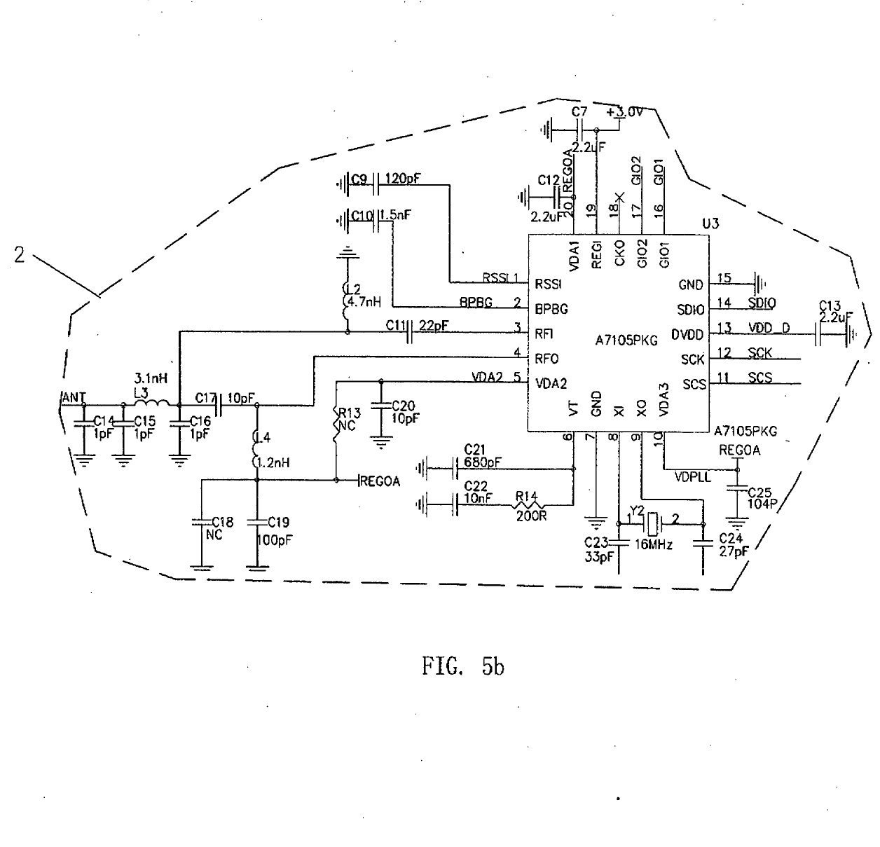

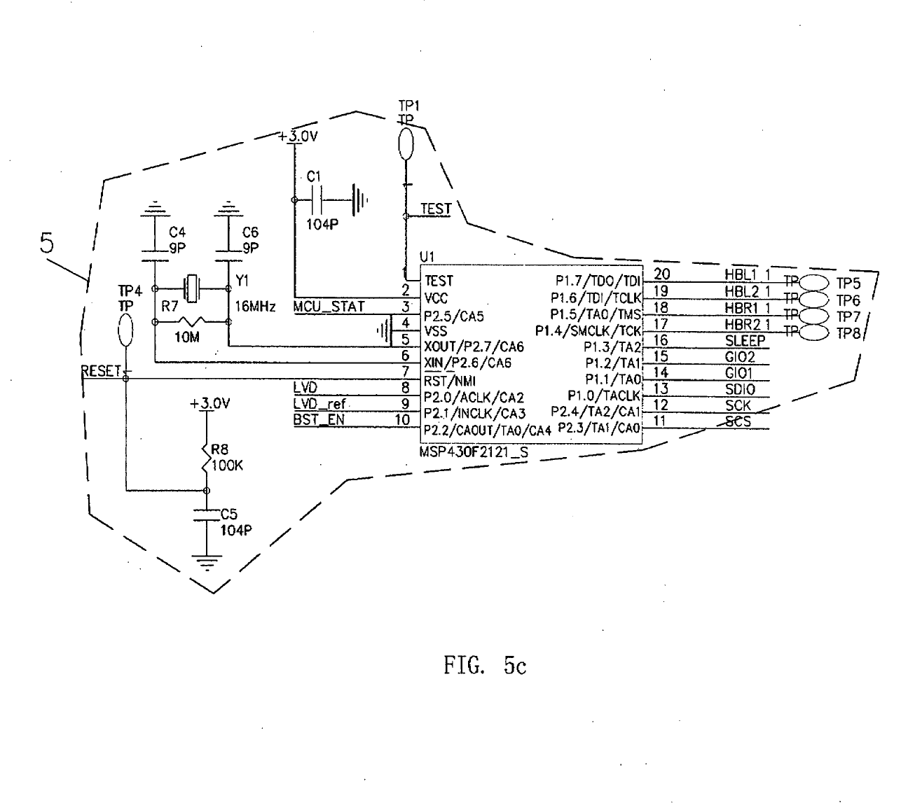

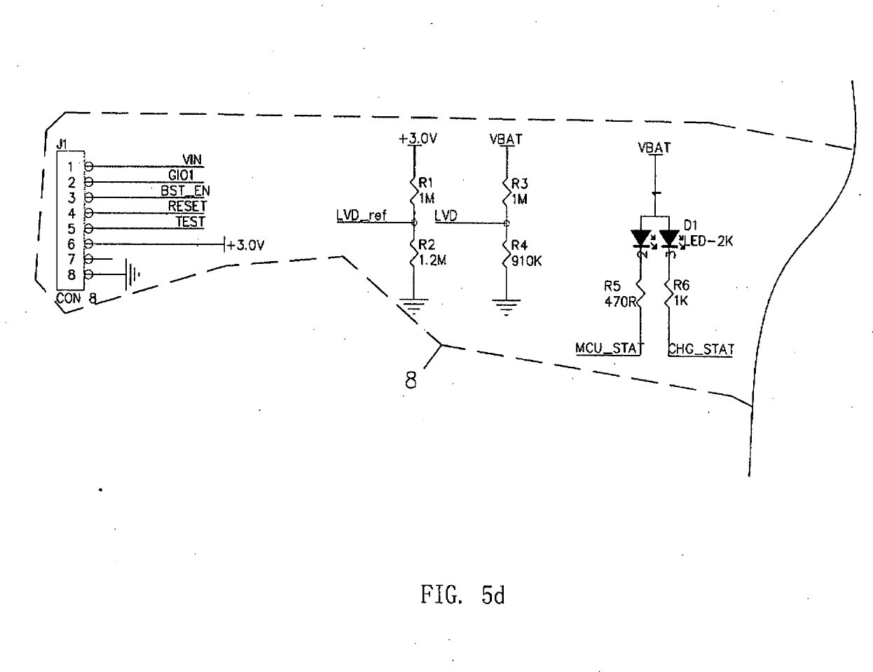

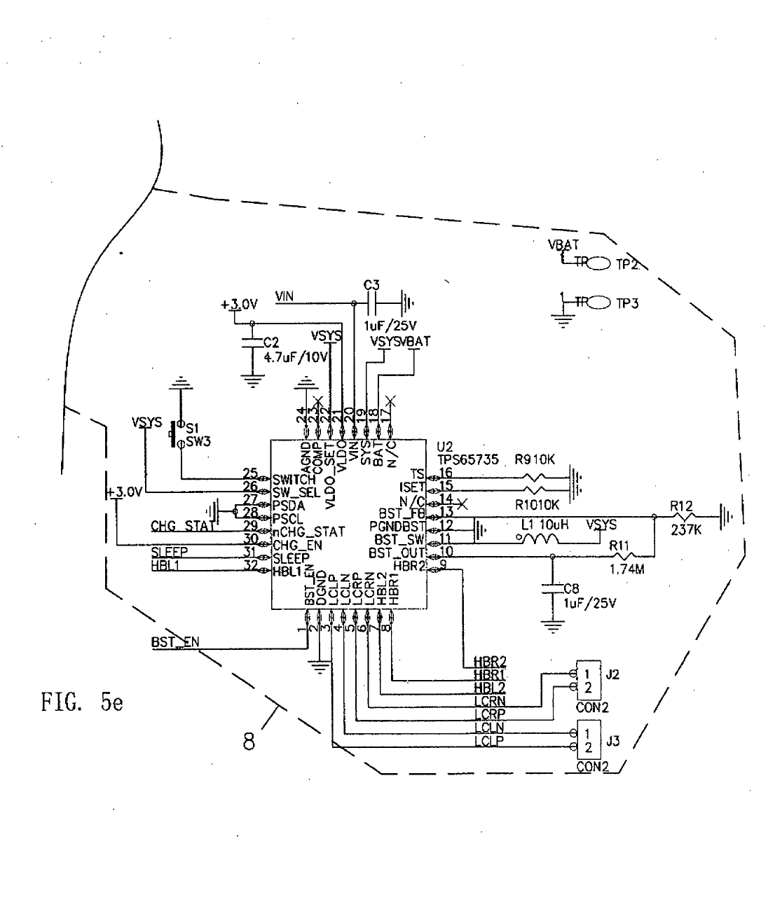

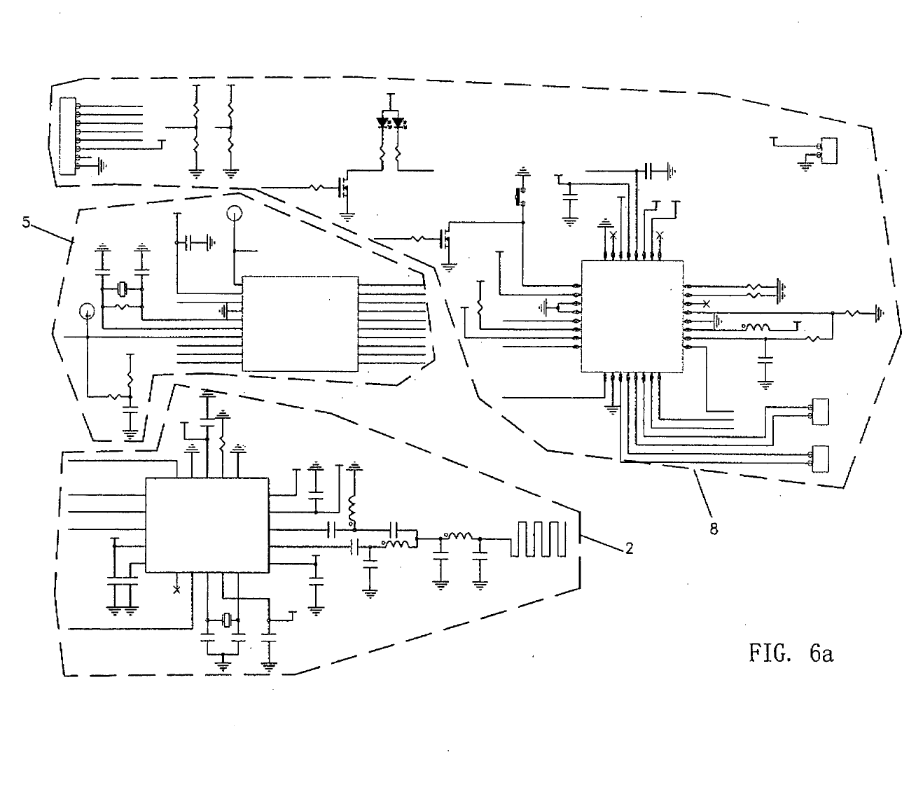

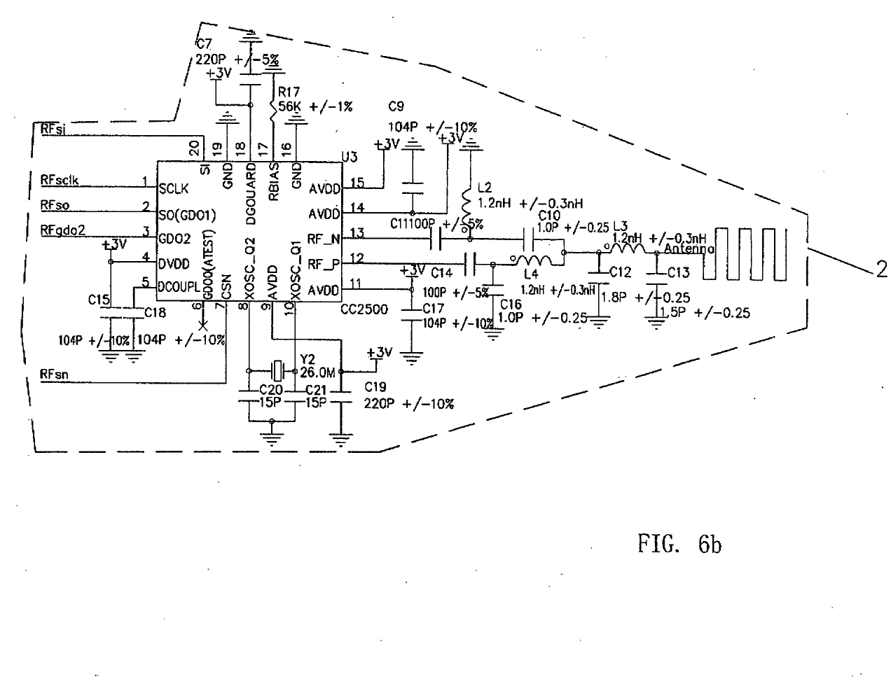

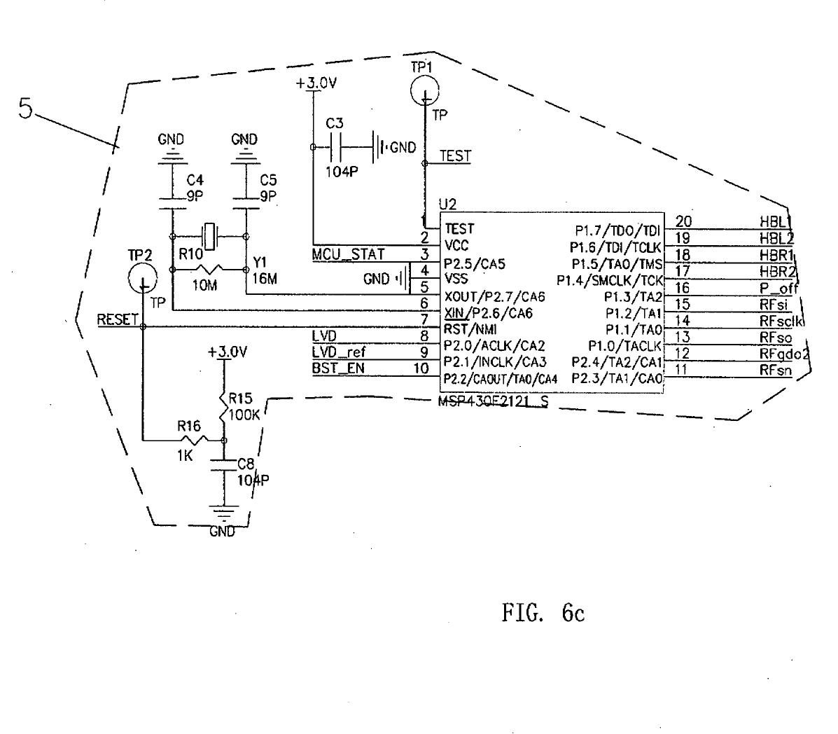

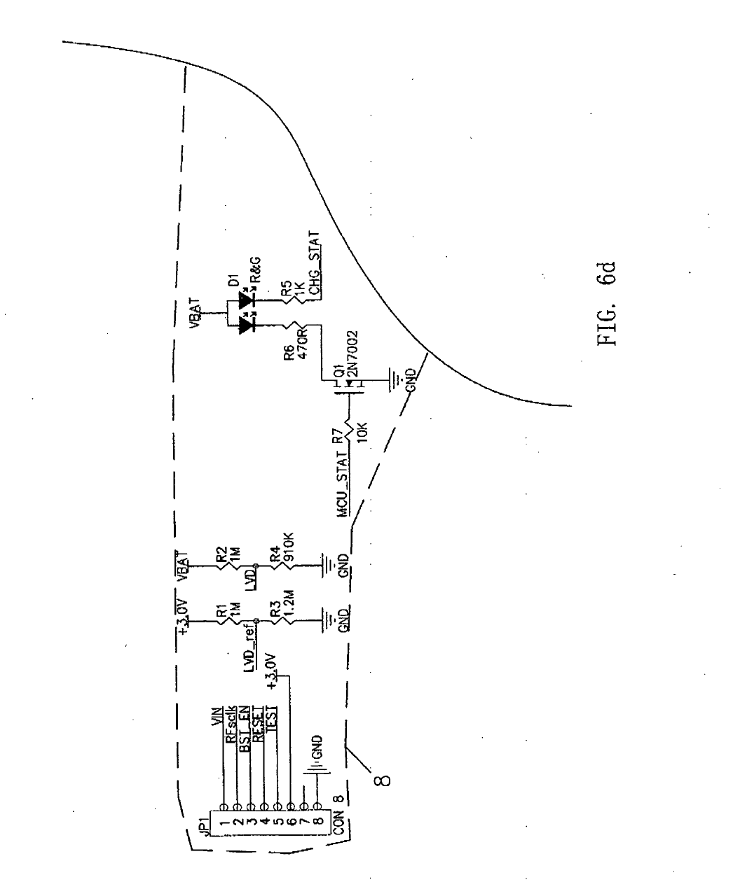

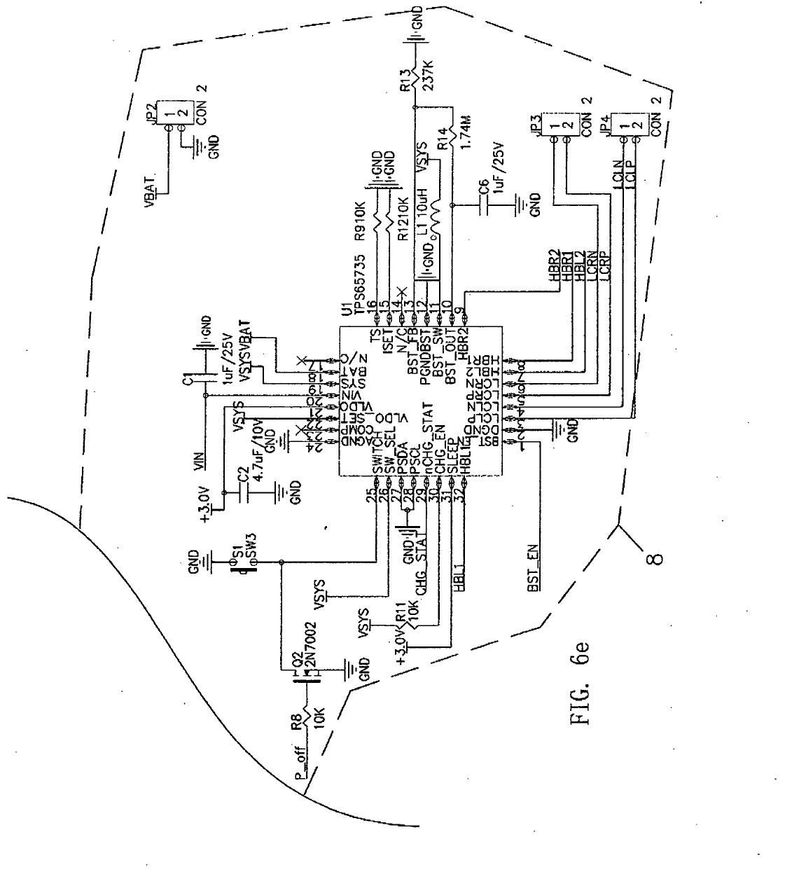

In the second embodiment, referring to FIGS. 2, 5-6, the 3D liquid crystal shutter glasses include left and right LCD lenses 1 and control circuit 30 associated with LCD lenses 1. The control circuit 30 associated with LCD lenses 1 comprises RF receiver 2, micro processor unit (MPU) 8, central processing unit (CPU) 5, and battery module 6, which are electronically associated in the way as shown in FIG. 1. FIGS. 5-6 respectively illustrate two specific electronic circuit diagrams of the control circuit 30, which are also protected in the scope of this invention.

The RF receiver 2 is used for receiving synchronization signal as described in the first embodiment.

Associated with the RF receiver 2, the MPU 8 is integrated of LCD driver, boost circuitry, and power control module therein. Chip such as TPS65735 or the like may be selected as the MPU 8.

The CPU 5 is respectively associated with the RF receiver 2 and MPU 8 so as to control them working. The CPU 5 may be selected as but not limited to the type of MSP430F2121.

The lithium battery 6 is associated with the MPU 8 for supplying power to the control circuit 30.

When the 3D glasses in operation in accordance with the second embodiment as shown in FIGS. 2, 5-6, the RF receiver 2 is provided to receive a synchronization signal from an external source which comes from a sync signal transmitter linked to a liquid crystal TV, digital projector, computers or any other three-dimensional or stereoscopic devices. The CPU 5 operates to control the RF receiver 2 receiving proper signals, and then outputs a command to the MPU 8 to control the LCD lenses turning on/off.

The MPU 8 has a regular voltage regulator, such as a low dropout regulator (LDO) of 3V & 2.2V, which supplies operating voltage to the RF receiver 2 and CPU 5. The power control module is integrated in the MPU 8 to control the battery 6 recharging. The boost circuitry is integrated in the MPU 8 to supply an operating voltage to the LCD driver. The LCD driver is integrated in the MPU 8 to control the operation of LCD lenses 1.

In operation, when the RF receiver 2 receives a sync signal, the CPU 5 will output a command according to the sync signal to the MPU 8, and thus the MPU 8 drives the left and right LCD lenses to turn on and off accordingly.

The lithium battery 6 as a power source is operable to power the whole control circuit 30.

While the invention has been described in conjunction with specific embodiments, it is evident that numerous alternatives, modifications, and variations will be apparent to those skilled in the art in light of the forgoing descriptions. The scope of this invention is defined only by the following claims.

What is claimed is:

1. 3D liquid crystal shutter glasses comprising:
LCD lenses; and
a control circuit associated with said LCD lenses;
wherein said control circuit is operable to receive sync RF signal and drive the LCD lenses operation.

2. The glasses according to claim 1, wherein said control circuit comprises:
an RF receiver for receiving sync RF signal;
an LCD driver for driving the LCD lenses operation;
a boost circuitry for supplying an operating voltage to the LCD driver;
a CPU for controlling said RF receiver, LCD driver and boost circuitry;
a power control module; and
a battery for powering said control circuit via said power control module.

3. The glasses according to claim 2, wherein said power control module is associated with said battery for controlling battery recharging.

4. The glasses according to claim 3, wherein the LCD driver is associated with LCD lenses; the boost circuitry is associated with said LCD driver; and the CPU is respectively associated with said RF receiver, LCD driver and boost circuitry.

5. The glasses according to claim 3, wherein said battery is a lithium battery, and said power control module employs a regular voltage regulator for voltage-stabilizing.

6. The glasses according to claim 5, wherein said voltage regulator is a kind of LDO.

7. The glasses according to claim 3, wherein the CPU controls the RF receiver to receive proper signals from a sync transmitter in an external source; according to the sync signal, the CPU outputs a command to the LCD driver for driving the LCD lens operation, and a command to the boost circuitry to power the LCD driver; according to the commands from the CPU, the boost circuitry outputs a drive voltage to the LCD driver, thereby said LCD driver starts to control the LCD lenses to turn on and off.

8. The glasses according to claim 3, wherein the RF receiver is selective from a chip of CC2500 or A7105; the LCD driver is selective from a chip of CD4053; and the CPU is selective from a chip of MSP430F2121 or MSP430F2132.

9. The glasses according to claim 2, wherein said LCD driver, boost circuitry and power control module are integrated in an MPU.

10. The glasses according to claim 9, wherein the CPU is respectively associated with the RF receiver and MPU; the RF receiver is associated with MPU; the battery is associated with MPU; and the MPU is associated with LCD lenses.

11. The glasses according to claim 9, wherein the MPU is selective from a chip of TPS65735.

12. The glasses according to claim 9, wherein the CPU controls the RF receiver receiving proper signals from a sync transmitter in an external source, and then the CPU outputs a command according to the sync signal to the MPU; thereby the MPU drives the LCD lenses to turn on and off.
